(19) United States
(12) Patent Application Publication
(10) Pub. No.: US 2011/0000573 A1
(43) Pub. Date: Jan. 6, 2011

(54) TUBULAR ARTICLE

(75) Inventor: JOHN PETER BOOTH, New Mill (GB)

Correspondence Address: Monument IP Law Group, 1717 Pennsylvania Avenue, Suite 900, Washington, DC, 20006, US

(73) Assignee: ITI SCOTLAND LIMITED, Glasgow (GB)

(21) Appl. No.: 12/830,686

(22) Filed: Jul. 6, 2010

(30) Foreign Application Priority Data
Jan. 8, 2008 (GB) 0800256.0
Jan. 7, 2009 (GB) PCT/GB2009/050008

(51) Int. Cl. F16L 9/16; B32B 3/00; B65D 85/00

(52) U.S. Cl. 138/154; 428/174; 206/389

(57) ABSTRACT

The present invention provides a strip and a tubular article formed from said strip which may, for example, be used in the oil and gas industry for transporting fluids which may be volatile fluids or corrosive fluids and which may be at elevated temperatures and/or pressure. The strip includes a plurality of combined step (joggle) and rib arrangements. In the finished assembled article, the strip is wound in helically self-overlapping relationship such as to allow corresponding step portions to sit one within the other. The step effectively provides the dual function of a joggle and a rib as known in the art and does so in a manner that reduces the forming stresses in the material and increases the strength of the final article.

### CROSS-REFERENCE TO RELATED APPLICATIONS

This application is a United States national phase application under 35 U.S.C. §371 of International Patent Application No. PCT/BG2009/050008, filed on Jan. 7, 2009, and claims the benefit of Great Britain Patent Application No. 0800256.0, filed on Jan. 8, 2009, both of which are incorporated by reference herein. The International Application was published as International Publication No. WO 2009/087415 A1 on Jul. 16, 2009.

### FIELD OF THE INVENTION

The present invention relates to a tubular article and relates particularly, but not exclusively, to a substantially rigid tubular article suitable for use in gas and fluid transportation by the oil and gas industry and being made from at least one strip of self overlapping helically-wound material. Such an arrangement may be used in the production of parallel or tapered elongate tubes and the like.

### BACKGROUND

U.S. Pat. No. 3,530,567 describes the formation of multi-layered tubular structures from a single strip comprising a number of joggle-steps across its width allowing self-overlapping strip portions to nestle within the space created by the joggle-step therefore forming a multi-layered tubular structure with constant diameter and constant width at any point along its length. The process of making the joggle-step involves creating a sharp bend created by forcing a portion of the strip off its natural plane thereby creating the joggle-step. The deformation required is likely to result in the formation of localised points of stress along its length, which may lead to microscopic cracks which could potentially propagate and, therefore, jeopardise the integrity of the tubular article itself. This effect would be significantly amplified when high strength materials such as ultra high strength steel is employed as such materials are not particularly ductile and cracking would occur much more readily.

U.S. Pat. No. 5,837,083 describes the formation of a multi-layered tubular article from a strip having a rib between joggle-steps which confers a number of additional beneficial properties to the tubular article such as an improvement of the axial and external collapse properties, improved flexibility and the provision of an external helical screw-thread like shape which may be used, for instance, to attach a flange or a connector. This rib also aids the manufacturing process in which it may be used to ensure the multiple layers of spirally wound strip are correctly located relative to each other. Unfortunately, this arrangement also relies on a joggle between the rib portions and the edges of the strip terminate short of the rib portions, thereby reducing the wall thickness within the rib, which is clearly very undesirable as it will have a detrimental affect on the structural integrity of the article itself.

In addition to the above, the discontinuities created by the overlap of the strip edges occurring at the joggle-step, which is usually located at mid-distance between two consecutive ribs, are areas of possible high localised axial stresses which are likely to be detrimental to the overall stability of the helically wound tubular structure.

U.S. Pat. No. 4,209,043 describes a method for making tubular articles by helically winding a strip in a self-overlapping manner in which the self-overlapping portion of the strip includes a rib which interlocks by means of serrated teeth which engage with a counterpart also located on the strip. The strip edges overlap at the rib section in the manner referred to above. Unfortunately, this arrangement only lends itself to the formation of a mono-layered tubular structures and the interlock/rib portion includes sharp edges and must be of a very flexible material if the interlocking portions are to engage with each other. This arrangement might not lend itself to use at elevated pressures and would be difficult to form from high tensile material. Such an arrangement may also be described as an unbalanced structure in that it is generally mono-layered and then overlaps simply at the edges of the strip.

EP1407707 discloses a rigid single layer helically wound pipe having an edge portion having a raised step which forms an interlocking feature for engagement with an edge of an adjacent strip portion whilst U.S. Pat. No. 6,668,867 discloses a similar arrangement used in a flexible tube arrangement.

From the above, it will be appreciated that a strip designed in such as way that it allows the use of high strength materials in the formation of pipes would considerably enhance the performance and use of such articles. Additionally, the use of high strength materials would allow for the passage of fluids at higher pressures and temperatures and, thereby, extend still further the operating capabilities of such articles.

### SUMMARY OF THE INVENTION

The present invention aims to provide a multi-layered tubular article obtained by helically winding a single self-overlapping strip of material for use particularly, but not exclusively, in the gas, oil or chemical industry in which the design of the strip has been modified with regards to the prior art in order to reduce or even suppress the undesirable effects known therein.

According to one aspect of the present invention there is provided, one or more strips of self overlapping helically-wound material, wherein said strip includes a first flat portion at a first inner diameter D¹, a second flat portion at a second outer diameter, a first step portion and a second step portion each spaced from the other across a width of said strip, wherein said first step portion is located between said first and second flat portions and comprises a curved step having an outer diameter greater than said second diameter and a first radius of curvature wherein said second step portion is located at an otherwise free end of said second flat portion and comprises a curved step having a second radius of curvature and wherein said second radius of curvature (R^{6,} R⁸) is greater than said first radius of curvature such as to allow said second step portion to overlap said first step portion. The curved step combines the functionality of a step or joggle and a rib allowing the formation of a multi-layered tubular structure having a low concentration of material stress within the joggle whilst also providing the functionality of the rib whilst preserving the axial properties and radial load carrying capabilities as well as retaining the helical screw-thread shape. The curved step offers a smoother and more rounded discontinuity of the material mainly provided by a longer radius of curvature which results in less localised axial stresses. Consequently, the use of higher strength material may now be contemplated and the applications of such tubular structure may be extended.

Preferably, said strip has a thickness T and each step portion includes a joining portion between said step and each directly adjacent flat portion and wherein said joining portion has a radius of curvature of greater than 2T and preferably 4T.

Advantageously, said strip includes a plurality of said flat portions at different diameters and a plurality of said step portions, each spaced from the other across a width of said strip.

In a particularly advantageous arrangement the strip includes a first edge portion at an edge of said strip on said first flat portion and wherein said first edge portion comprises a curved profile extending radially outward from a plane of the first flat portion.

In an alternative arrangement said second step portion comprises a second edge portion at an edge of said strip on said second flat portion and wherein said second edge portion comprises a curved profile extending radially outward from a plane of the first portion and terminating at a diameter greater than that of the outer diameter D².

In the preferred arrangement the radius of curvature of the plurality of said step portion increases between the inner diameter of said strip and the outer diameter thereof such as to allow outer step portions to overlap corresponding inner step portions.

Advantageously, the strip is married to a liner portion within said tubular structure.

According to another aspect of the invention there s provided a strip suitable for forming into a helically wound tubular structure as described above having a first flat portion at a first level L1, a second flat portion at a second level L2 greater than said first level L1, a first step portion and a second step portion each spaced from the other across a width of said strip, wherein said first step portion is located between said first and second flat portions and comprises a curved step at a third level L3 greater than said second level L2 and a first radius of curvature, wherein said second step portion is located at an otherwise free end of said second flat portion and comprises a curved step having a second radius of curvature and wherein said second radius of curvature is greater than said first radius of curvature such as to allow said second step portion to overlap said first step portion.

Preferably, said strip has a thickness T and each step portion includes a joining portion between said step and each directly adjacent flat portion and wherein said joining portion has a radius of curvature of greater than 2T and preferably 4T.

Advantageously, said strip includes a plurality of said flat portions at different levels and a plurality of said step portions, each spaced from the other across a width of said strip.

In a particularly advantageous arrangement a first edge portion at an edge of said strip on said first flat portion and wherein said first edge portion comprises a curved profile extending radially outward from a plane of the first flat portion.

In a still further advantageous arrangement said second step portion comprises a second edge portion at an edge of said strip on said second flat portion and wherein said second edge portion comprises a curved profile extending radially outward from a plane of the first portion and terminating at a level greater than that of level L2.

The radius of curvature of the plurality of said step portion increases between adjacent flat portions across the width of said strip such as to allow outer step portions to overlap corresponding inner step portions when said strip is helically wound into a pipe formation.

The present invention also contemplates the provision of a cassette for holding or containing a strip as described above.

### BRIEF DESCRIPTION OF THE DRAWINGS

The present invention will now be more particularly described by way of example only with reference to the accompanying drawings in which:

FIG. 1 is an isometric view of a strip having a step feature incorporated in the present invention;

FIG. 2 is a cross-sectional view of the strip of FIG. 1;

FIG. 3 is a cross-sectional view of a portion of a finished article manufactured from a strip as shown in FIGS. 1 and 2;

FIG. 4 is an end cross sectional view of a finished article manufactured from a strip as shown in FIGS. 1 to 3;

FIG. 5 is a cross-sectional view of the strip according to one aspect of the present invention and including a profiled inner edge portion;

FIG. 6 is a detailed partial cross-sectional view of an assembled plurality of strips of FIG. 5 shown in self-overlapping relationship;

FIG. 7 is a cross-sectional view of a strip according to a second aspect of the present invention and includes a profiled outer edge;

FIG. 8 is a detailed partial cross-sectional view of an assembled plurality of strips of FIG. 7 shown in self-overlapping relationship;

FIG. 9 is a cross-sectional view of the strip according to a third aspect of the present invention and including profiled inner and outer edge portions;

FIG. 10 is a detailed partial cross-sectional view of an assembled plurality of strips of FIG. 9 shown in self-overlapping relationship;

FIG. 11 is a partial cross-sectional view of a pair of rollers suitable for forming the strips described herein;

FIG. 12 is a diagrammatic representation of a cassette loaded with strip material as described herein; and

FIG. 13 illustrates a further arrangement providing one or more plane ribs between combined rib/joggle portions.

### DETAILED DESCRIPTION OF THE INVENTION

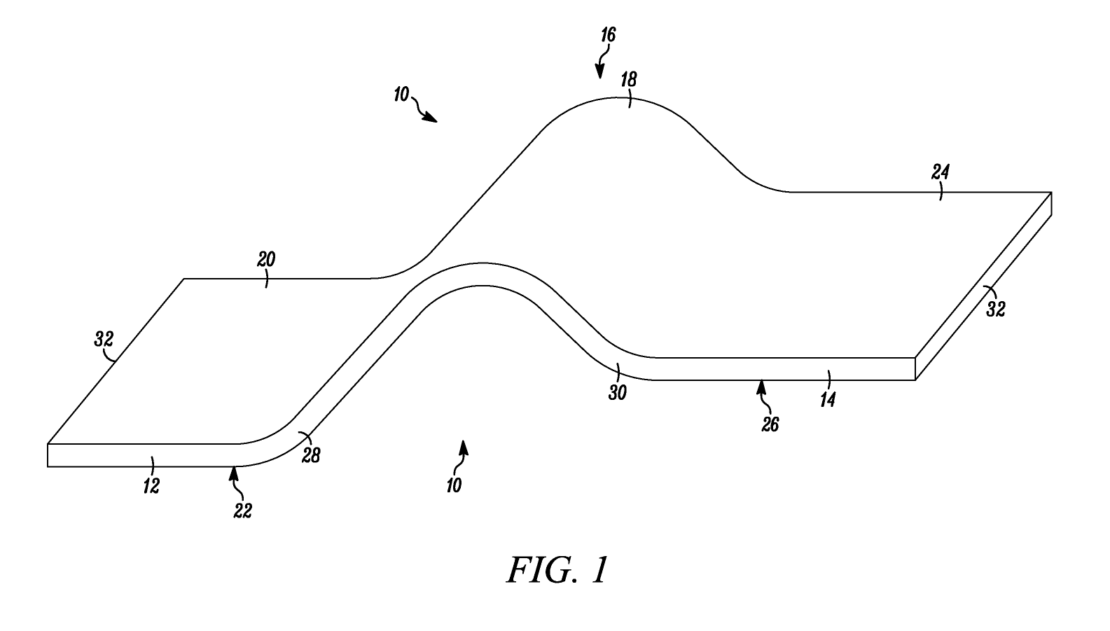

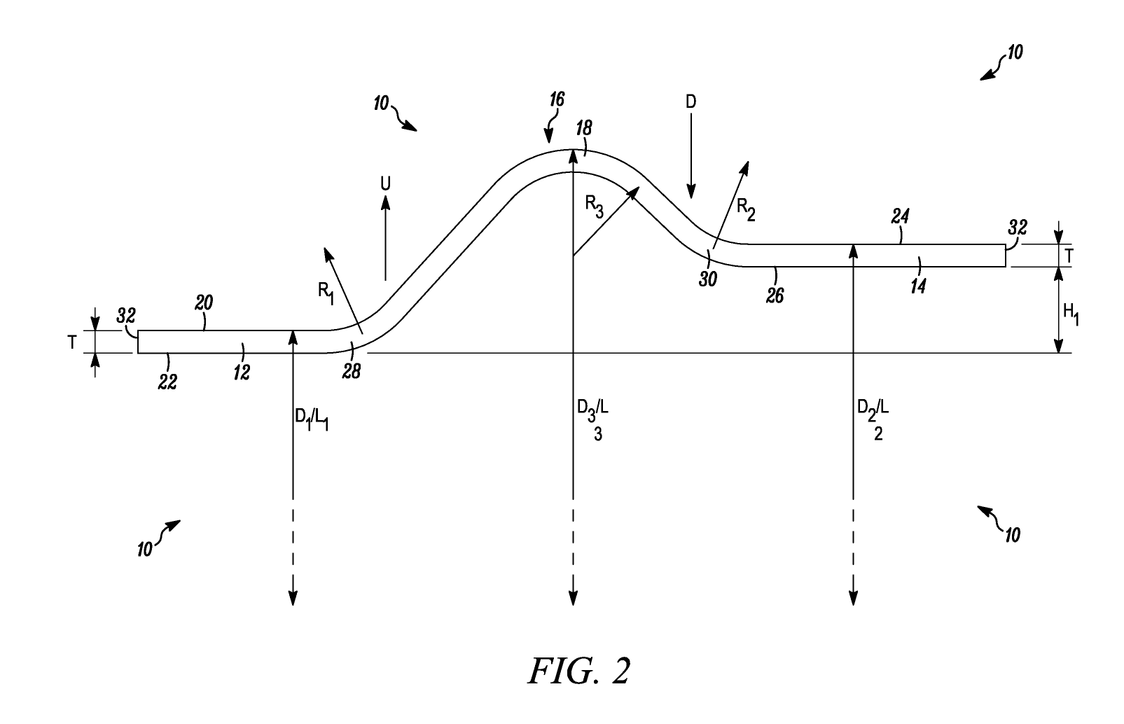

Referring now to the drawing in general but particularly to FIGS. 1 and 2, a strip 10 of material, such as metal, has a thickness T and includes a first flat portion 12 at a first inner diameter D¹ orlevel L1 and a second flat portion 14 at a second outer diameter D² or level L2 and a step portion 16 therebetween. The step portion 16 comprises a curved step 18 rising first upwardly in the direction of arrow U and then downwardly in the direction of arrow D and having an outer diameter D³ or level L3 greater than said second outer diameter D² orlevel L2. This step portion effectively creates the joggle and the rib of the prior art whilst reducing the severity of bending associated with the prior art joggle and thereby reducing the localised stressing of the material. Said first flat portion 12 comprises a top surface 20 and a bottom surface 22, and, in the same manner, said second flat portion 14 also comprises a top surface 24 and a bottom surface 26. The surfaces of the first and second flat portions extend generally parallel to each other but are spaced apart by an amount H1 which is such as to allow the thickness T of the first portion to be accommodated within the confines of the second portion, when wound in self-overlapping relationship. It will be appreciated however that H1 may be equal to T if no adhesive is being used. The curved step 18 is provided with a first joining portion 28 between itself and the first flat portion 12 and a second joining portion 30 between itself and the second flat portion 14. The joining portions 28 and 30 are each of a curved profile having a given radius R1 or R2 which is preferably of a radius equal to or greater than 2T and optionally up to, say, 4T, for reasons that will be explained in detail later herein. The main portion of the step 16 is formed with a radius of R3 selected to be such as not to cause undue cracking or stress within the material during any forming process. The general rules discussed above may be applied equally here. It will be appreciated that other bend radii may be employed depending on the ductility of the material being used.

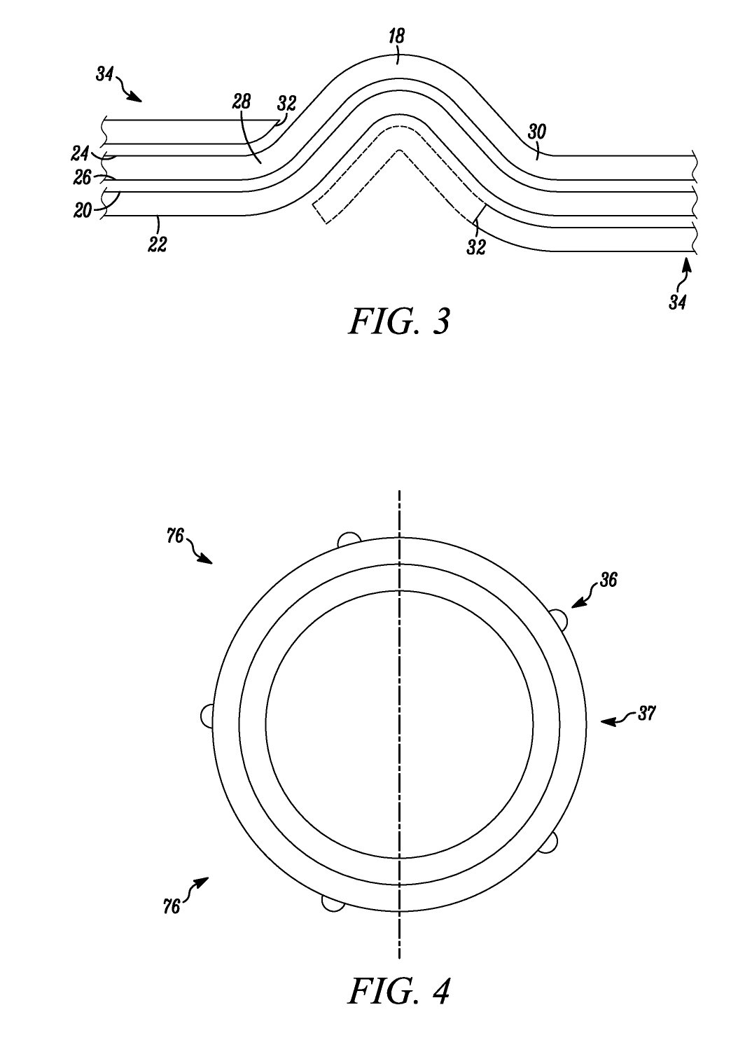

Referring briefly to FIG. 3, It will be appreciated that the new strip design allows the edges 32 of the strip to be positioned immediately adjacent to the combined curved step/rib portion 18, as shown, which is an area of increased strength rather than at a mid portion between ribs 34, as in the prior art, which is an area of reduced strength. In a more balanced structure the strip is provided with a rib at each edge thereof such as to ensure three layers are present at each joggle/rib 18. Such an arrangement is illustrated with dotted lines in FIG. 3. In some arrangements it is possible or indeed desirable to form a rib/joggle 18 with a flattened top portion (Not shown).

FIG. 4 is a cross-sectional view of a tubular article that may be manufactured from the above-discussed strip 10 and illustrates the raised step/rib portions at 36 and the multiple layers at 37.

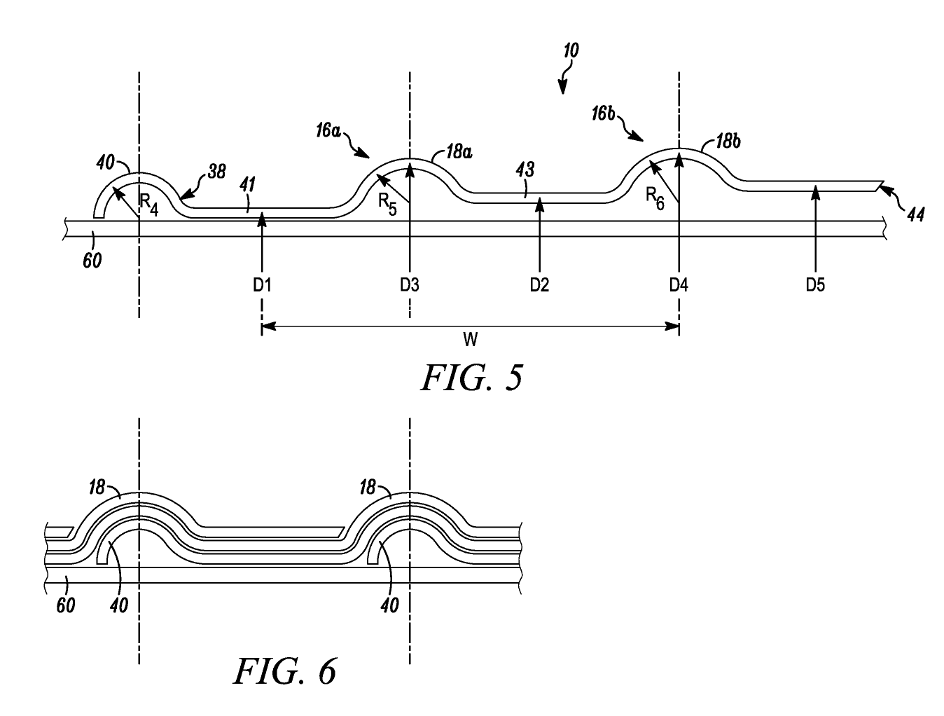

The above described features are utilised in arrangements of the present invention which are depicted most clearly in FIGS. 5 to 8. From FIG. 5 it will be appreciated that one edge 38 of said strip 10 is profiled to provide a curved section 40 having a generally upwardly and then downwardly extending curve having a radius R4 following the general profile discussed above. This profile is selected such as to mate with corresponding curved steps 18 that may be placed thereover in a subsequent forming process. This arrangement thereby allows for any subsequently formed article to have the same number of layers at the combined step/rib portion 16 as may be provided at the generally flat portions 12 and 14, thereby increasing still further the rigidity and burst strength of any final article. FIG. 5 also illustrates the case of a strip including a plurality of said curved steps 18a, 18b in which the radius of curvatures R5 and R6 increasing between adjacent flat portions as one looks across the strip itself such as to allow multiple outer portions 14 to overlap corresponding inner portions 12. FIG. 6 aptly illustrates the advantages of the arrangement of FIG. 5 and from which it will be appreciated that the end curved portion 40 nestles comfortably within the profile of the curved step 18 placed thereover and ensures that the article is provided with the same number of layers at two out of three step portions 16.

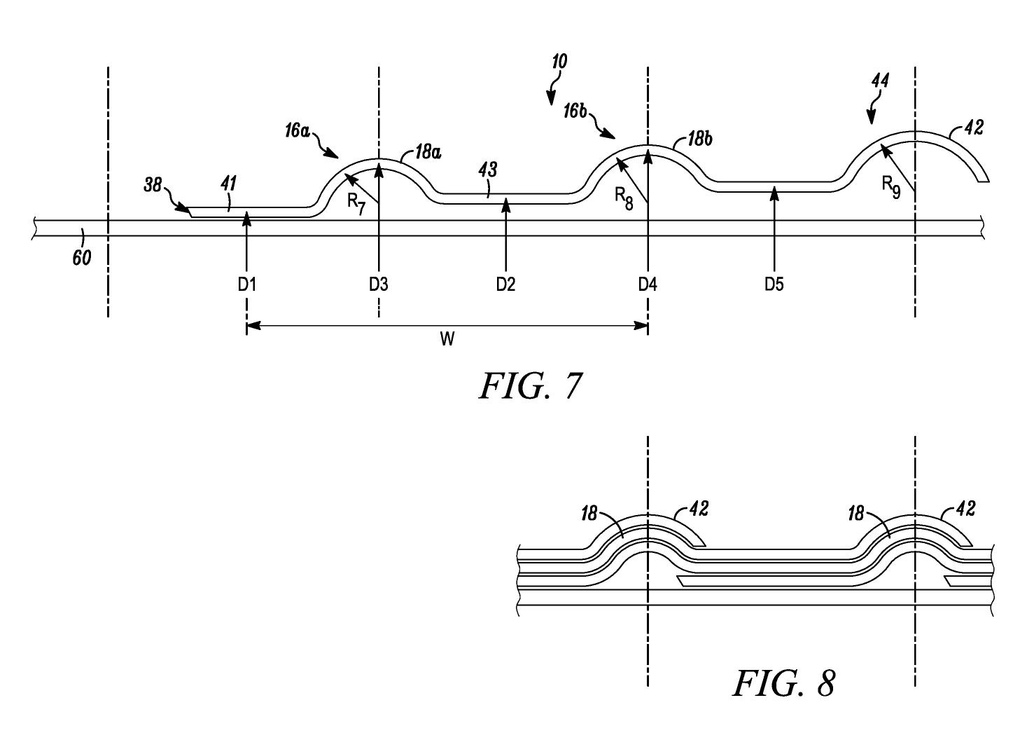

FIG. 7 illustrates an alternative arrangement to that shown in FIG. 5 in which the curved section 42 is provided on an opposite edge 44 and at the larger diameter or level. The Radii R7 to R9 each increase relative to their immediate and inner neighbour such as to accommodate an immediately adjacent portion when the strip 10 is wound into a tubular article as shown in FIG. 3. In addition to the above, it will be appreciated that the larger of the curved edges 42 terminates slightly short, such as to allow it to nestle over an immediately adjacent to but lower curved step 18 when assembled into a finished article. FIG. 8 aptly illustrates this nestling arrangement and from which it can be appreciated that the curved edge portion 42 terminates just short of the point at which it would interfere with the layer therebelow.

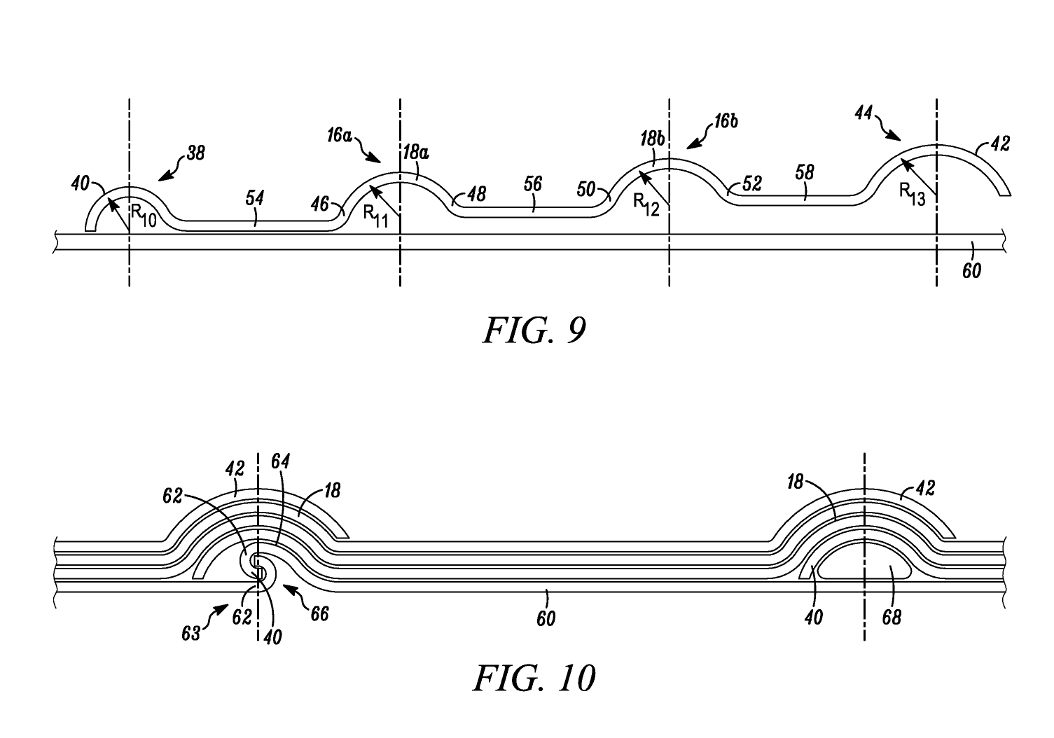

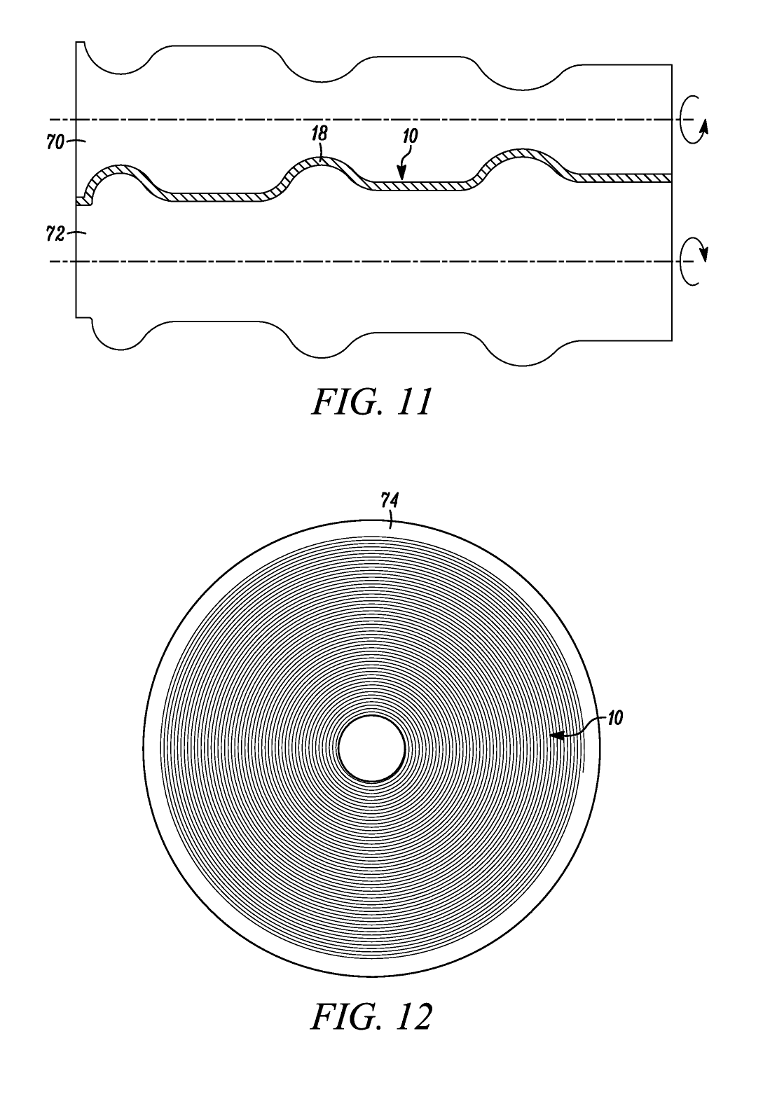

The reader will appreciate that the mid portion step portions 16 comprising curved steps 18a, 18b perform the function of steps and ribs thus providing two features in one and allowing a gentle curve to be applied to the step which, in the prior art, is often a relatively sharp and difficult to produce step change in the material profile. In addition, the number of individual profiles on any forming rollers can be reduced as one individual profile portion can form both the step and the rib profile. This feature is applied commonly to the arrangements of FIGS. 5 and 7 which also incorporate an edge curved portion which increases the strength at a critical location on the structure and to those in FIGS. 9 and 10 which provide edge curved portions at both edges of the strip. Common reference numerals 40 and 42 have, therefore, been used to highlight this aspect.

Reference is now made more particularly to FIGS. 9 and 10 which illustrate a further arrangement of the present invention in which profiled curved edge portions 40 and 42 are provided on each of the two edges 38 and 44. In this arrangement the step portions 16 and curved portions 40 and 42 are each of a different radii R10 to R13 corresponding broadly to radii R4 to R6 and R7 to R9 of FIGS. 5 and 7. Each step portion 16 also includes a joining portion 46, 48, 50, 52 associated with adjacent flat portions 54, 56, 58, the properties of which correspond to those described above with reference to FIGS. 1 to 8. When assembled into a finished article, as shown in part in FIG. 10, this arrangement allows for the provision of additional layers at each of the raised step portions 16. Such a feature contributes to the increased structural integrity of the finished article. A further feature of the present invention is shown in each of the main drawings and comprises a liner 60 which acts to shield the strip material from the contents of any material being passed along a finished article. Such material may comprise corrosive materials such as acids, fuels, oil and the like or abrasive materials such as slurries or crude oil. It will be appreciated from FIG. 10 that the liner itself may be formed by a spiral winding process in which the edges 62 thereof are swaged one over the other so as to create a unitary liner tube as best seen at 63 in FIG. 10. The process of formation is by way of forge welding under pressure and heat to create a lock seam joint 66 in the liner which is much more able to withstand burst pressures than simple adhesively bonded structures or turned edges. Another advantage of this swaging feature resides in the fact that the swaged portion can “space-fill” the recess 64 formed by the step portion 16 and the curved edge portion 40 when applicable, thereby allowing an immediate passage of any internal pressure through the lining 60 and into the outer casing where it may be more easily reacted due to the high strength of the casing material. Alternatively, the recess 64 may be filled with a quadrant of steel wire 68, a structural adhesive or some such similar material which, again, space-fills the void and allows for the passage of internal pressure directly to the casing. This wire may be of a high tensile material such as to allow it to contribute the structural integrity of the finished article itself or it may simply be of a load carrying material having other properties such as porosity, in which case it could act as a conduit for the escape of any gas or fluid that might find its way into the gap between the lining 60 and the casing.

The main difficulty associated with making a correct welded joint (by laser, TIG, MIG etc i.e. conventional welding procedures) on thin steel strip is to get the correct abutment of the edges touching. Any gap however small may result in an imperfection in the welded joint i.e. blow hole etc. Making a forge welded lock seam joint allows for an margin of error in the edge geometry because one first mechanically lock the edges together by roll forming correct strip edge features and the forge welding this lock seam together for an homogenous connection which avoids the problems of the prior art. This is particularly an advantage when joining the strip edges at higher speeds (approx. 5 mtrs/min) as it would be extremely difficult to detect and rectify any errors before the next step of over winding with martinsite strip. It is worth highlighting that the martinsite layers are mechanically locked together by the nesting of the ribs which aids axial properties, flexibility, ease and repeatability of manufacture and taking away the total reliability of achieving axial properties by adhesive bonding alone. The liner to martinsite outer layer is adhesive bonded but the liner contributes little axial properties to the overall structure's performance of the pipe so reliance on the bond is reduce. The liner only acts as a corrosion resistant barrier ie like a bladder or inner tube of a tyre. Mechanically locking the liner to the martinsite layers via a lock seam forge welded joint nesting in the rib void could be sufficiently beneficial to dispense with the adhesive altogether and simply rely on the future friction lock system resulting from the corrugated method of strip overlapping.

It will be appreciated that the arrangements of FIGS. 9 and 10 provide a curved portion 40, 42 at the edges of the strip which, when fully engaged, provide the finished product with an extra layer of strengthening material at the joint line. This additional material greatly enhances the burst strength of the pipe as the extra material is provided at the joint line of the liner itself 60. The main reason for the additional layer resides in the fact that the rib under internal pressure encounters the highest stresses mainly due to axial extension of the pipe section. The rib deforms under this internal pressure i.e. reduces in height and gets longer i.e. opens up. All the rib radii are subjected to higher stresses than the flat portions due to this deformation. These stresses are both compressive and tensile dependent on being located in the intrados or extrados of the bend. Putting an additional layer at this location stiffens this area locally and reduces the level of stress at the radii because the rib has been reinforced locally.

Referring now to FIGS. 11 and 12, it will be appreciated that the strip described above may be formed by passing a pre-cut flat strip between a pair, or multiple pairs, of profiled rollers 70, 72 such as to deform the strip into the described cross-sectional profile. This forming step may be carried out significantly before a subsequent winding operation or may be carried out as the winding process is being undertaken. If the former arrangement is adopted then the strip may be supplied in it's formed state already pre-loaded into a carrying cassette 74 formed specifically to carry the strip from the forming station at, for example, the steel mill to the point at which the finished article is to be manufactured. This point may be in a factory, adjacent to the point of use or actually at the point of eventual use.

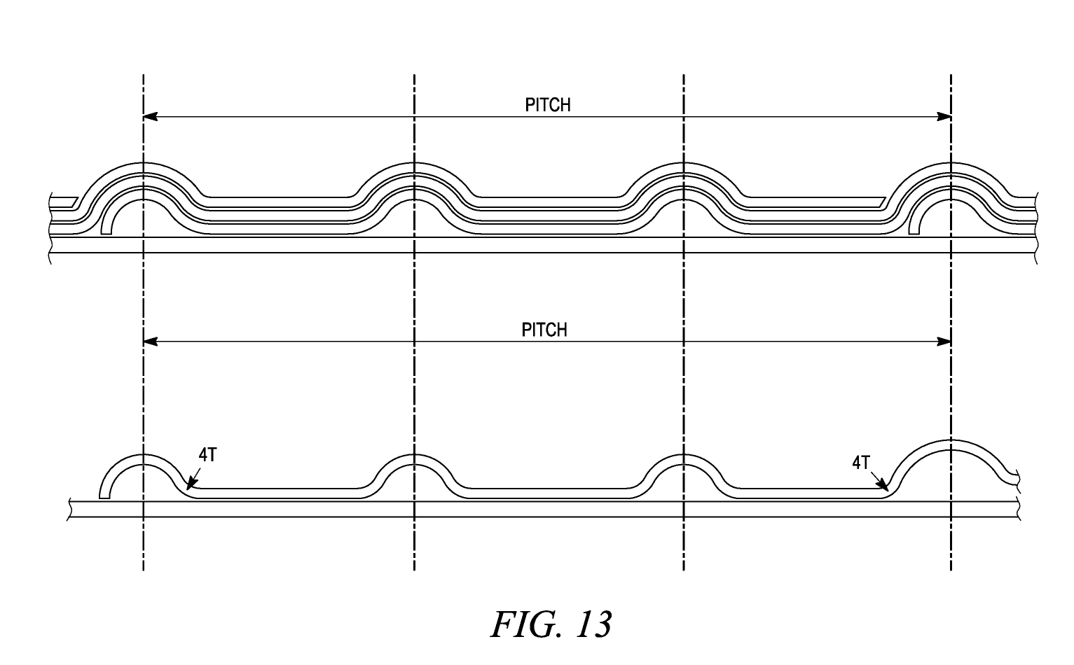

FIG. 13 illustrates a further embodiment in which one or more plane ribs 90 are provided in the otherwise flat portions between combined rib/joggle portions 18. The figure shows just one pitch of the strip and the reader will appreciate that the rib diameter will increase between pitches such as to allow the ribs to sit on top of the other, as shown in the top portion of FIG. 13. The plain ribs provide additional flexibility.

Manufacture of a finished tubular article 76 as shown in FIG. 4 simply requires the employment of the process of self-overlapping spiral winding as known in the prior art. In this process a strip 10 is wound such that subsequent layers are would over previously deposited layers such that corresponding curved step portions 18 nestle one within the other as shown in the above figures. The curved step portion 18 actually acts as a guide encouraging each successive layer to align correctly with that below. An apparatus suitable for use in the manufacturing process is not shown herein but may comprise a rotating winding head having a supply of strip material of pre-formed cross-section supplied thereto by means of the above cassette 74. Alternatively, the forming apparatus may include a plurality of forming rollers for forming the desired cross-sectional profile as the strip is would into the final article. Such arrangements are known in the art and, therefore, not described in further detail herein.

It will be appreciated that the above-described arrangement provides a robust helically-wound tubular article suitable for the storage or transportation of corrosive or other materials which may be stored or transported under higher than atmospheric pressure. Indeed, as the low stress manufacturing process lends itself to the use of high tensile steels such as Martinsite™ or other high strength metals such as high carbon steel, titanium and other high performance materials. It will, however, also be appreciated that the present arrangement may be used to produce strip and tubular articles from lower and more ductile materials such as copper, aluminium and low carbon steels.

In addition to the above, it will be appreciated that by providing the joggle step in the form of a combined rib and joggle having a generally gently curved profile it is possible to reduce and possibly eliminate the stresses associated with the prior known approaches.

Still further, it will be appreciated that by providing the rib/joggle portions as described above, it is possible for the edges of the strip to terminate within the ridge portion which is an area of increased strength rather than between said ridge portions which will create an area of weakness.

It is important to note that in the arrangements described above, and particularly in FIGS. 5 to 10 and 13, one or more plane ribs (40, 42 for example) are provided on one or more sides of combined rib/joggle portions 18.

An additional benefit of the combined rib/joggle portion resides in the fact that it will help strip laydown or strip nestling and the final profile is more flexible/compliant than the simple joggle arrangement alone.

What is claimed is:

1. A tubular article comprising one or more strips of self overlapping helically-wound material, wherein said strip includes a first flat portion at a first inner diameter D¹, a second flat portion at a second outer diameter D², a first step portion and a second step portion each spaced from the other across a width W of said strip,
wherein said first step portion is located between said first and second flat portions and comprises a curved step having an outer diameter D³ greater than said second diameter D² and a first radius of curvature (R^{5,}, R⁷),
wherein said second step portion is located at an otherwise free end of said second flat portion and comprises a curved step having a second radius of curvature (R^{6,} R⁸),
and wherein said second radius of curvature (R^{6,} R⁸) is greater than said first radius of curvature (R^{5,}, R⁷) such as to allow said second step portion to overlap said first step portion.

2. A tubular article as claimed in claim 1 wherein said strip has a thickness T and each step portion includes a joining portion between said step and each directly adjacent flat portion and wherein said joining portion has a radius of curvature of greater than 2T and preferably 4T.

3. A tubular article as claimed in claim 1 wherein said strip includes a plurality of said flat portions at different diameters and a plurality of said step portions, each spaced from the other across a width of said strip.

4. A tubular article as claimed in claim 1 and including a first edge portion at an edge of said strip on said first flat portion and wherein said first edge portion comprises a curved profile extending radially outward from a plane of the first flat portion.

5. A tubular article as claimed in claim 1 wherein said second step portion comprises a second edge portion at an edge of said strip on said second flat portion and wherein said second edge portion comprises a curved profile extending radially outward from a plane of the first portion and terminating at a diameter greater than that of the outer diameter D².

6. A tubular article as claimed in claim 3 wherein the radius of curvature of the plurality of said step portion increases between the inner diameter of said strip and the outer diameter thereof such as to allow outer step portions to overlap corresponding inner step portions.

7. A tubular article as claimed in claim 1 and including a liner portion within said tubular structure.

8. A strip suitable for forming into a helically wound tubular structure according to claim, said strip comprising a first flat portion at a first level L1, a second flat portion (43, 56) at a second level L2 greater than said first level L1, a first step portion (16a) and a second step portion (16b) each spaced from the other across a width W of said strip,
wherein said first step portion is located between said first and second flat portions and comprises a curved step at a third level L3 greater than said second level L2 and a first radius of curvature (R^{5,}, R⁷),
wherein said second step portion is located at an otherwise free end of said second flat portion and comprises a curved step (18b) having a second radius of curvature (R^{6,} R⁸), and wherein said second radius of curvature (R^{6,} R⁸) is greater than said first radius of curvature (R^{5,}, R⁷) such as to allow said second step portion to overlap said first step portion.

9. A strip as claimed in claim 8 wherein said strip has a thickness t and each step portion includes a joining portion between said step and each directly adjacent flat portion and wherein said joining portion has a radius of curvature of greater than 2t.

10. A strip as claimed in claim 8 wherein said strip includes a plurality of said flat portions at different levels and a plurality of said step portions, each spaced from the other across a width of said strip.

11. A strip as claimed in claim 8 and including a first edge portion at an edge of said strip on said first flat portion and wherein said first edge portion comprises a curved profile extending radially outward from a plane of the first flat portion.

12. A strip as claimed in claim 8 wherein said second step portion comprises a second edge portion at an edge of said strip on said second flat portion and wherein said second edge portion comprises a curved profile extending radially outward from a plane of the first portion and terminating at a level greater than that of level L2.

13. A strip as claimed in claim 8 and wherein the radius of curvature of the plurality of said step portion increases between adjacent flat portions across the width W of said strip such as to allow outer step portions to overlap corresponding inner step portions when said strip is helically wound into a pipe formation.

14. A cassette containing a wound coil of strip according to claim 8.
